(19) United States
(12) Patent Application Publication
(10) Pub. No.: US 2004/0049138 A1
(43) Pub. Date: Mar. 11, 2004

(54) Head massager

(76) Inventor: James Li, Arcadia, CA (US)

Correspondence Address: JOE NIEH, 17800 CASTLETON STREET, SUITE 475, CITY OF INDUSTRY, CA, 91748, US

(21) Appl. No.: 10/242,270

(22) Filed: Sep. 11, 2002

(51) Int. Cl. A61H 7/00

(52) U.S. Cl. 601/137

(57) ABSTRACT

A massaging device for massaging a person's head is disclosed. The head massager comprises of a hand-held housing that encloses an electric motor that may be battery operated. An eccentric weight is attached to the axle of the electric motor such that when the electric motor is activated, the eccentric weight will rotate and induce a vibration to the head massager. The hand-held housing has multiple strands of flexible wires fixably attached to its bottom that define an open cavity generally in the shape of a human head. When a person places his head inside the cavity defined by the multiple strands of flexible wires, the multiple strands of flexible wires will apply pressure to the user's head. When the electric motor inside the hand-held housing is activated, a vibration will be induced in the entire head massager and the multiple strands of flexible wires will deliver the vibration to the user's head to increase the effectiveness of the head massager. The head massager may rest on top of the user's head or may be moved about the user's head to distribute the massage to different locations of the user's head.

### BACKGROUND

1. Field of the Invention

Massage is the act of treating the body by rubbing, patting, or the like, as to stimulate circulation or relieve tension. A massager is a person or device that performs the massage. The device may be a simple mechanical device with fixed or movable parts or a mechanical device with electronic or electrical components Massage may be performed by a person or a device that simulates or improves upon a person's act of massage

The present invention relates generally to a device for performing massage More specifically, the present invention relates to a head massager that can be used to massage a person's head and scalp. In particular, the present invention is a mechanical device with electrical components that can be used to massage a person's head and scalp easily and effectively

2. Description of the Related Art

A massage may be performed by a person or a device that simulates or enhance a person's act of massage. That person may be the receiver of the massage himself or another who does the massage for him. It is difficult, if not impossible, to reach some locations of the body for a person to massage himself Therefore, when a person is massaging himself, generally a mechanical device is utilized to rub, pat, apply pressure, or reach the area of the body to be massaged.

Conventional massaging devices may be made of a variety of materials such as wood, rubber, plastic, aluminum, and steel. The massaging device may have a fixed shape with no movable parts that can be simply held by a user's hand to rub on or apply pressure to desired locations on the body. The massaging device may also have movable components such as wheels, springs, and balls that can move along the user's body to either increase comfort or increase the effectiveness of the massaging device

Improvements to the conventional massaging devices generally comprises of adding electrical or electronic components to the massaging device. One of the most common improvements is the massaging chair that utilizes a motorized massaging device that travels along a predefined path along the length of the chair to massage the user's neck and back when the user is sitting in the chair Another common improvement to the conventional massaging device is the addition of an electric motor with an eccentric weight attached to its axis so that when the electric motor is activated the entire unit will vibrate due to the rotation of the eccentric weight The vibration will increase the effectiveness of the massaging device. These improvements have only been applied to massaging devices for generally flat portions of the body. None of the designs have ever used any electrical or electronic components to any device specifically designed for massaging the head of the user.

### SUMMARY OF THE INVENTION

The present invention is a massaging device for massaging a person's head The present invention comprises of a hand-held housing that encloses an electric motor that may be battery operated An eccentric weight is attached to the axle of the electric motor such that when the electric motor is activated, the eccentric weight will rotate and induce a vibration to the massaging device. The hand-held housing has multiple strands of flexible wires fixably attached to its bottom that define an open cavity generally in the shape of a human head When a person places his head inside the cavity defined by the multiple strands of flexible wires, the multiple strands of flexible wires will apply pressure to the user's head. When the electric motor inside the hand-held housing is activated, a vibration will be induced in the entire massaging device and the multiple strands of flexible wires will deliver the vibration to the user's head to increase the effectiveness of the massaging device. The massaging device may rest on top of the user's head or may be moved about the user's head to distribute the massage to different locations of the user's head

### BRIEF DESCRIPTION OF THE DRAWINGS

FIG. 1 shows a perspective view of the head massager.

FIG. 2 shows the left side view of the head massager

FIG. 3 shows the front view of the head massager

FIG. 4 shows the right side view of the head massager.

FIG. 5 shows the rear view of the head massager.

FIG. 6 shows the top view of the head massager.

FIG. 7 shows bottom view of the head massager

FIG. 8 shows a sectional view of the head massager.

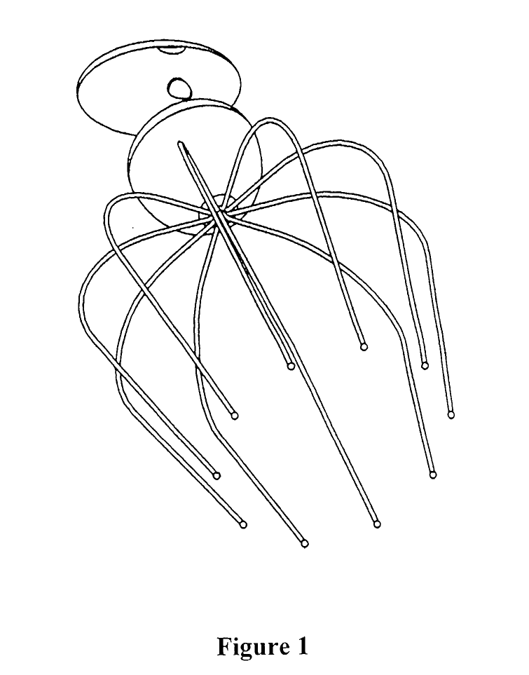

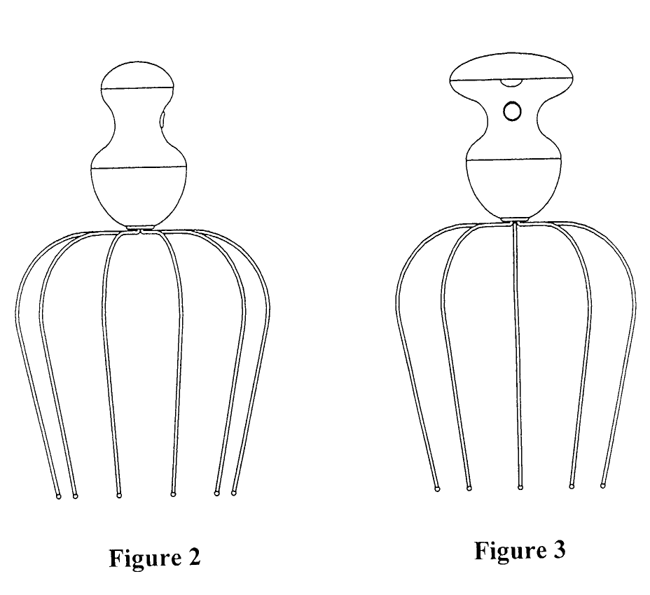

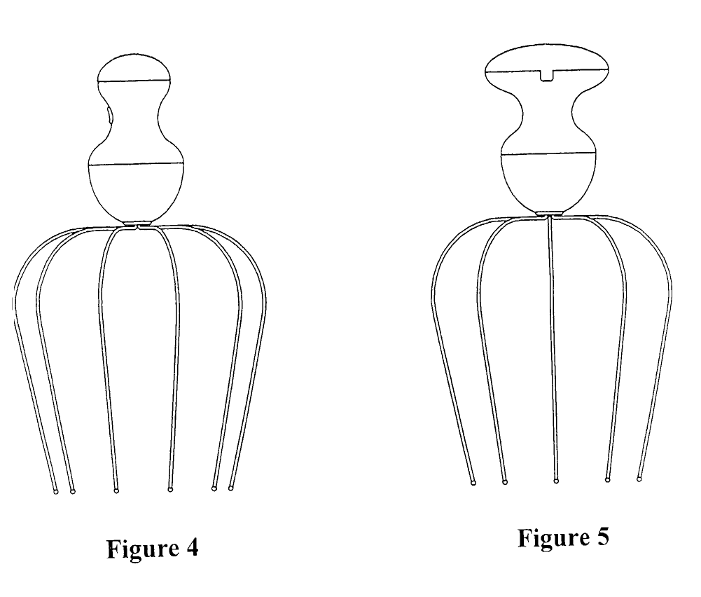

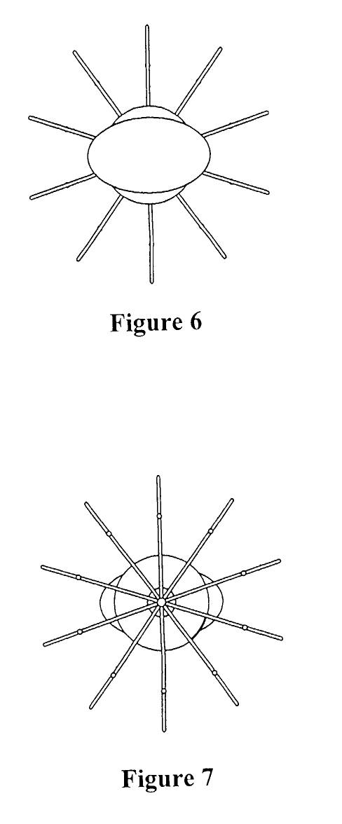

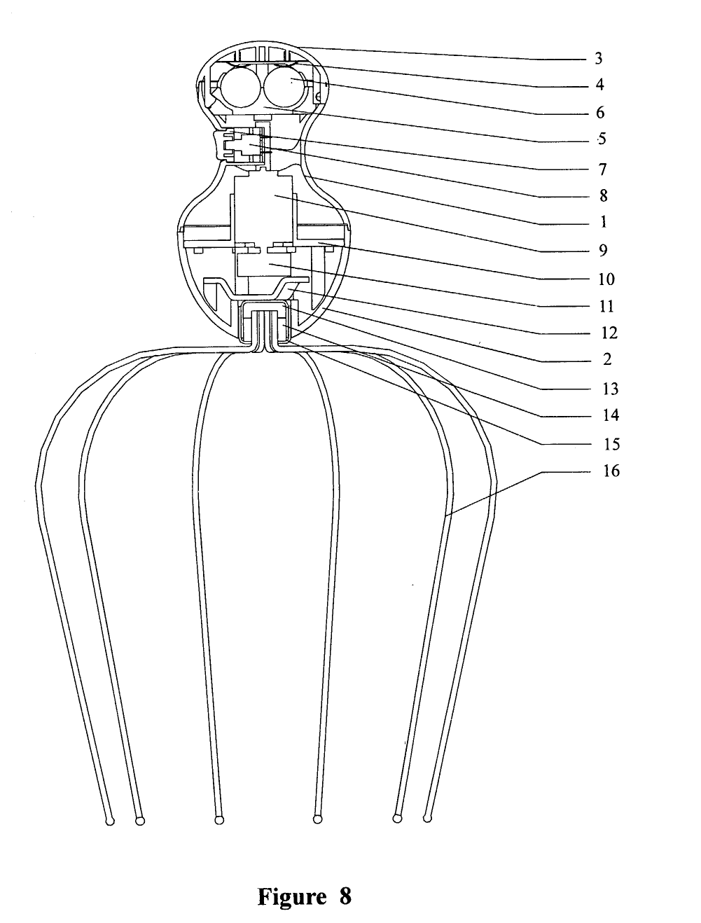

### DETAILED DESCRIPTION OF THE PREFERRED EMBODIMENT

In the preferred embodiment of the present invention, the head massager comprises of a hand-held housing enclosing one or more batteries 6 in electrical connection through a switch 8 to a battery operated electric motor 9 with an eccentric weight 11 attached to its axis and multiple strands of flexible wires 16 defining a cavity generally in the shape of a human head fixably attached to the bottom of the hand-held housing. When the switch 8 is activated, the battery operated electric motor 9 will operate and rotate its axis. Due to the eccentric weight 11 attached to the axis, the rotation of the axis with the eccentric weight 11 will induce a vibration to the head massager and increase the effectiveness of the head massager.

The hand-held housing in the preferred embodiment of the present invention comprises of a body with an upper shell 1 and a lower shell 2. The upper shell I has an opening for the switch 8 to extend through so the use may depress the switch 8 A battery case 5 is fixably attached to the top of the upper shell 1 to receive the batteries 6. A battery cover 3 with a spring plate 4 fixably attached under it is removably attached to the top of the battery case 5 to enclose the batteries 6 in the battery case 5 and to allow the changing of the batteries 6 when they are exhausted The batteries 6 are in electrical connection through the switch 8 to a battery operated electric motor 9 fixably attached to a motor stand 10 and enclosed in the upper shell 1 An eccentric weight 11 is attached to the axis of the electric motor 9 and enclosed in the lower shell 2. A fixture 12 in the lower shell 2 retains the multiple strands of flexible wires 16 that are affixed in the inner-bushing 14 and outer bushing 13 enclosed in an aluminum bushing 15.

The multiple strands of flexible wires 16 define a cavity generally in the shape of a human head to receive a user's head When the user inserts his head into the head massager and depresses the switch 8, the vibration generated by the electric motor 9 with the eccentric weight 11 will gently massage the user's head with the multiple strands of flexible wires 16.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given

What is claimed is

1. A head massager comprising:
a vibration means, and
multiple strands of flexible wires generally defining a cavity in the shape of a human head and attached to the vibration means;
wherein the head massager device may be placed over a user's head enclosing the user's head in the cavity to massage the user's head with the vibrating multiple strands of flexible wires.

2. A head massager according to claim 1, wherein said vibration means comprises of an electric motor with an eccentric weight attached to its axis whereby when electricity is applied to the electric motor, the rotation of the electric motor's axis with the eccentric weight will induce a vibration to the head massager

3. A head massager according to claim 1, wherein said multiple strands of flexible wires are made of metal.

4. A head massager according to claim 1, wherein said multiple strands of flexible wires are made of copper

5. A head massager according to claim 1, wherein said multiple strands of flexible wires terminate in rounded ends.

6. A head massager according to claim 2, wherein said multiple strands of flexible wires are made of metal

7. A head massager according to claim 2, wherein said multiple strands of flexible wires are made of copper

8. A head massager according to claim 2, wherein said multiple strands of flexible wires terminate in rounded ends.

9. A head massager comprising.
a vibration means, and
multiple strands of flexible wires generally defining a cavity in the shape of a human head and fixably attached to the vibration means;
wherein the head massager device may be placed over a user's head enclosing the head in the cavity to massage the user's head with the vibrating multiple strands of flexible wires.

10. A head massager according to claim 9, wherein said vibration means comprises of an electric motor with an eccentric weight attached to its axis whereby when electricity is applied to the electric motor, the rotation of the electric motor's axis with the eccentric weight will induce a vibration to the head massager

11. A head massager according to claim 9, wherein said multiple strands of flexible wires are made of metal

12. A head massager according to claim 9, wherein said multiple strands of flexible wires are made of copper.

13. A head massager according to claim 9, wherein said multiple strands of flexible wires terminate in rounded ends.

14. A head massager according to claim 10, wherein said multiple strands of flexible wires are made of metal.

15. A head massager according to claim 10, wherein said multiple strands of flexible wires are made of copper

16. A head massager according to claim 10, wherein said multiple strands of flexible wires terminate in rounded ends.
